(19) United States
(12) Patent Application Publication
(10) Pub. No.: US 2022/0383088 A1
(43) Pub. Date: Dec. 1, 2022

(54) PARAMETER ITERATION METHOD FOR ARTIFICIAL INTELLIGENCE TRAINING

(71) Applicant: Han-Wei Zhang, New Taipei City (TW)

(72) Inventor: Han-Wei Zhang, New Taipei City (TW)

(21) Appl. No.: 17/325,680

(22) Filed: May 20, 2021

(51) Int. Cl. G06N 3/08; G06K 9/62

(52) U.S. Cl. CPC G06N 3/08; G06K 9/6228; G06K 9/6265

(57) ABSTRACT

A parameter iteration method for artificial intelligence training includes: providing a training set and setting a numerical range; selecting at least three initial set values from the numerical range, calculating an accuracy rate of the initial set values, and setting a first parameter range by using the initial set value having a highest accuracy rate; selecting at least three first iteration values from the first parameter range, calculating an accuracy rate of the first iteration values, comparing the accuracy rates of the first iteration values with each other, and setting a second parameter range by using the first iteration value having a highest accuracy rate as a second core value; and determining whether the accuracy rate of the second core value is higher than 0.9, and setting the second core value as a training parameter standard value if higher than 0.9.

### BACKGROUND

### Technical Field

This application relates to the field of artificial intelligence, an in particular, to a parameter iteration method for artificial intelligence training.

### Related Art

With advancement of science and technology, artificial intelligence is applied to increasing aspects. For example, artificial intelligence is gradually applied to defect detection, face recognition, medical judgement, and the like. Before general artificial intelligence actually enters an application field, data usually needs to be trained. The data may be trained by using algorithms such as a neural network, a convolutional neural network (CNN), or the like.

Currently, deep learning of the CNN is a most common learning and training method for image discrimination. Since current training parameters are usually random number settings, and an amount of inputted data is huge, a large amount of calculation data is generated during calculation process. As a result, burdens of memories and computing resources are relatively large, resulting in a long training time and poor efficiency.

### SUMMARY

A parameter iteration method for artificial intelligence training is provided herein. The parameter iteration method for artificial intelligence training includes a setting step, an initialization step, a parameter optimization step, and a determination step. The setting step includes providing a training set and setting a numerical range for at least two training parameters. The initialization step includes randomly selecting at least three initial set values from the numerical range for the training parameters, calculating an accuracy rate of each of the initial set values according to the training set, and setting a first parameter range by using the initial set value having a highest accuracy rate as a first core value and using a parameter coordinate value of the first core value as a physical center. The parameter optimization step includes selecting at least three first iteration values from the first parameter range, calculating an accuracy rate of each of the first iteration values according to the training set, comparing the accuracy rates of the at least three first iteration values, and setting a second parameter range by using the first iteration value having a highest accuracy rate as a second core value and using a parameter coordinate value of the second core value as a physical center. The determination step includes determining whether the accuracy rate of the second core value is higher than 0.9, if the accuracy rate of the second core value is higher than 0.9, ending the parameter optimization step and setting the second core value as a training parameter standard value, or if the accuracy rate of the second core value is not higher than 0.9, replacing the first core value and the first parameter range with the second core value and the second parameter range respectively, repeating the parameter optimization step until an accuracy rate of a test core value is higher than 0.9, and setting parameter coordinates of the test core value as the training parameter standard value.

In some embodiments, the at least two training parameters include a batch size and a learning rate, the batch size ranges from 0.5 to 1.5, the learning rate ranges from 0.5 to 1.5, and the first parameter range is a circle on a coordinate system having the batch size and the learning rate as a horizontal axis and a vertical axis respectively, which has the first core value as a center of the circle. More specifically, in some embodiments, the batch size ranges from 0.7 to 1.3, and the learning rate ranges from 0.7 to 1.3.

More specifically, in some embodiments, in the initialization step, the selection of the batch sizes and the learning rates of the initial set values and the calculation of the accuracy rate are performed by two graphics processors respectively.

In some embodiments, at least two parameters further include a momentum ranging from 0 to 1, and herein, the first parameter range is a sphere on a coordinate system having the batch size, the learning rate, and the momentum as an x-axis, a y-axis, and a z-axis respectively, which has the first core value as a center of sphere. More specifically, the momentum ranges from 0.3 to 0.8.

In some embodiments, the at least two parameters further include a normalization ranging from 0.00001 to 0.001, and the first parameter range is a physical quantity range on a coordinate system having the batch size, the learning rate, the momentum, and the normalization as an x-axis, a y-axis, a z-axis, and a w-axis respectively, which has the first core value as a physical center. More specifically, in some embodiments, the normalization ranges from 0.0001 to 0.0005.

In some embodiments, in the initialization step, any two of the batch size, the learning rate, the momentum, and the normalization are selected by a first graphics processor, the other two of the batch size, the learning rate, the momentum, and the normalization are selected by a second graphics processor, and the accuracy rate is calculated by a third graphics processor.

In some embodiments, the parameter iteration method for artificial intelligence training further includes a verification step. The verification step includes providing a test set, calculating the accuracy rate by using the second core value or the test core value in the determination step that has the accuracy rate higher than 0.9, and performing the initialization step again if the accuracy rate calculated according to the test set is lower than 0.9.

In conclusion, through the parameter iteration method for artificial intelligence training, parameter values can be more quickly selected, and an overall artificial intelligence training process can be accelerated, thus achieving faster gradient descent of the artificial training with fewer files at a larger speed, which can shorten a training time and significantly improve training efficiency.

### BRIEF DESCRIPTION OF THE DRAWINGS

FIG. 1 is a flowchart of a parameter iteration method for artificial intelligence training.

FIG. 2 is a schematic diagram of an initialization step.

FIG. 3 and FIG. 4 are schematic diagrams of a parameter optimization step.

### DETAILED DESCRIPTION

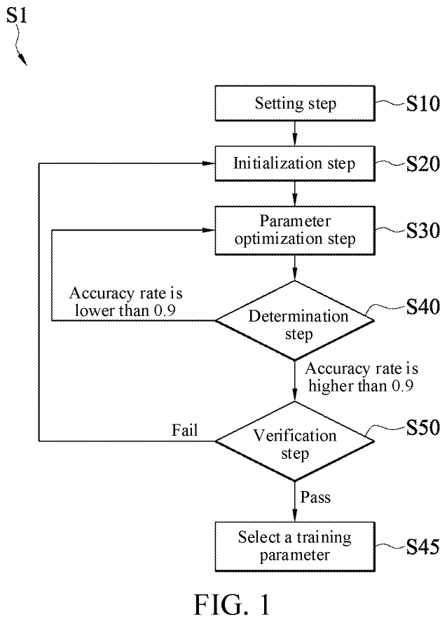

FIG. 1 is a flowchart of a parameter iteration method for artificial intelligence training. As shown in FIG. 1, a parameter iteration method S1 for artificial intelligence training includes a setting step S10, an initialization step S20, a parameter optimization step S30, and a determination step S40.

The setting step S10 includes providing a training set and setting a numerical range for at least two training parameters. The artificial intelligence training is performed through a convolutional neural network (CNN) by using a model of a stochastic gradient descent method as a training set herein. The model may be equation (I) shown below. However, this is merely an example but not a limitation. The training set herein further includes algorithms such as loss calculation.

$${w}_{t + 1} = {w}_{t} - η \frac{1}{n} {\sum }_{x ∈ ℬ} ∇ l ( x , {w}_{t} ) . , \qquad Equation ( I )$$

where w represents a weight, n is a batch size, and η is a learning rate.

As shown in equation (I), the batch size and the learning rate actually affect convergence of the weight. When the batch size is large, a number of batches can be reduced, thereby reducing a training time. However, on the contrary, a larger amount of learning requires a larger number of iterations, resulting in poor performance of the model and a larger amount of generated data. An excessively small learning rate indicates a very small weight update range, resulting in very slow training. An excessively large learning rate results in a failure to converge. Therefore, in addition to providing a proper training set, the setting step S10 also needs to set a range for parameters. For example, the set parameters include a batch size and a learning rate. The batch size ranges from 0.5 to 1.5, and the learning rate ranges from 0.5 to 1.5. Preferably, the batch size ranges from 0.7 to 1.3, and the learning rate ranges from 0.7 to 1.3. However, the above is merely an example but not a limitation, and relevant parameters are not limited to the batch size and the learning rate.

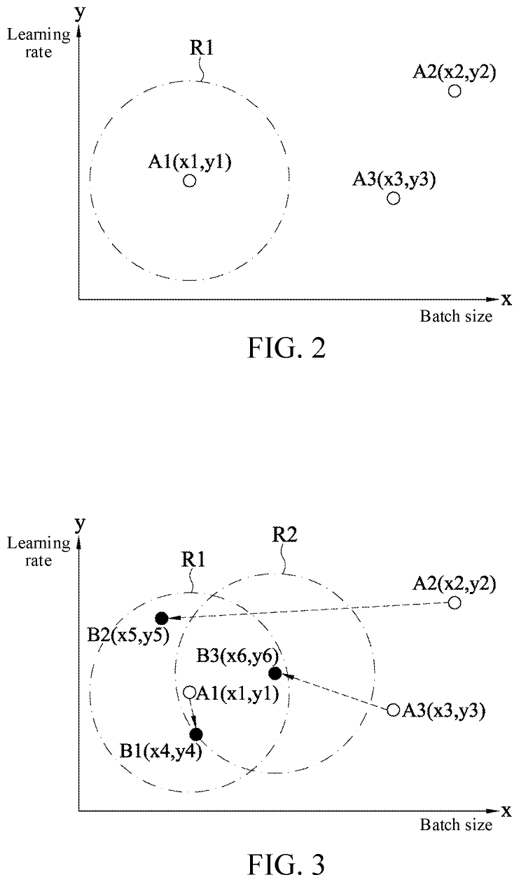

FIG. 2 is a schematic diagram of an initialization step. As shown in FIG. 2, the initialization step S20 includes randomly selecting at least three initial set values A1, A2, and A3 from the numerical range for the training parameters. For example, herein, coordinate values of the randomly selected three initial set values A1, A2, and A3 on a coordinate system having the batch size as a horizontal axis and the learning rate as a vertical axis are (x1, y1), (x2, y2), (x3, y3) below. This is merely for ease of presentation on a plane, and actual parameters are not limited thereto.

Then an accuracy rate of each of the three initial set values is calculated according to the training set. The accuracy rate (ACC) is calculated through 1-loss. The three calculated accuracy rates are compared, and a first parameter range R1 is set by using the initial set value (for example, A1) of the at least three initial set values A1, A2, and A3 that has a highest accuracy rate as a first core value and using a parameter coordinate value (x1, y1) of the first core value as a physical center. The first parameter range R1 herein is a circle on the coordinate system having the batch size and the learning rate as a horizontal axis and a vertical axis respectively, which has the first core value (x1, y1) as a center of circle. A radius of the circle may be ½ \sqrt{(x1²+y1²)} herein. However, this is merely an example, and a specific radius value may also be pre-selected as the first parameter range R1.

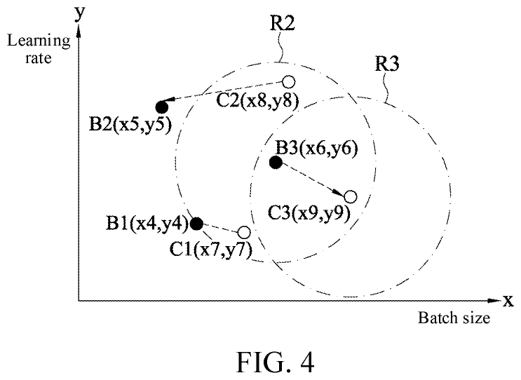

FIG. 3 is a schematic diagram of a parameter optimization step. As shown in FIG. 3, the parameter optimization step S30 includes selecting at least three first iteration values B1, B2, and B3 from the first parameter range R1, calculating an accuracy rate of each of the first iteration values B1, B2, and B3 according to the training set, comparing the accuracy rates of the at least three first iteration values B1, B2, and B3, and setting a second parameter range R2 by using the first iteration value (for example, B3) of the at least three first iteration values that has a highest accuracy rate as a second core value and using a parameter coordinate value (x6,y6) of the second core value as a physical center. A radius of the circle may be ½\sqrt{(x6²+y6²)} herein. However, this is merely an example, and a specific radius value may also be pre-selected as the first parameter range R1.

The determination step S40 includes determining whether the accuracy rate of the second core value is higher than 0.9, if the accuracy rate of the second core value is higher than 0.9, ending the parameter optimization step and performing S45 of performing training by selecting the second core value (x6, y6) as a training parameter standard value.

FIG. 4 is a schematic diagram of the parameter optimization step. As shown in FIG. 4, if it is determined in the determination step S40 that the accuracy rate of the second core value is not higher than 0.9, the first core value (x1, y1) and the first parameter range R1 are replaced with the second core value (x6, y6) and the second parameter range R2 respectively, the parameter optimization step S30 is repeated, at least three second iteration values C1, C2, and C3 are selected, an accuracy rate of each of the second iteration values C1, C2, and C3 is calculated according to the training set, the accuracy rates of the at least three second training set values C1, C2, and C3 are compared, and a third parameter range R3 is set by using the second iteration value (for example, C1) of the at least three second iteration values that has a highest accuracy rate as a third core value and using a parameter coordinate value (x7, y7) of the third core value C1 as a physical center. A radius of the circle may be ½\sqrt{(x7²+y7²)} herein. The determination step S40 and the parameter optimization step S30 may be repeated in this way until an accuracy rate of a test core value is higher than 0.9, and parameter coordinates of the test core value are set as the training parameter standard value.

Referring to FIG. 1 again, the parameter iteration method S1 for artificial intelligence training further includes a verification step S50. The verification step S50 includes providing a test set. Values in the test set are different from those in the training set. In the verification step S50, the accuracy rate is calculated according to the test set by using the second core value or the test core value in the determination step S40 that is obtained by subsequently repeating the parameter optimization step S30 and that has the accuracy rate higher than 0.9. If the accuracy rate calculated according to the test set is higher than 0.9, the second core value or the test core value is set as the training parameter standard value. If the accuracy rate is lower than 0.9, the parameter is discarded, and the initialization step S20 is performed again.

In the above embodiment, in the initialization step S20, the selection of the batch sizes and the learning rates of the initial set values and the calculation of the accuracy rate are performed by two graphics processors respectively. In other words, selection of the initial set values A1, A2, and A3 in FIG. 2 and calculation of the accuracy rates of the initial set values A1, A2, and A3 are performed by two graphics processors respectively. In this way, computing resources of the graphics processors can be dispersed to achieve faster computing efficiency.

However, FIG. 2 to FIG. 4 are merely examples. Parameters that actually affect training efficiency further include a momentum and a normalization. If three parameters such as a batch size, a learning rate, and a momentum are set, it may be understood that the first parameter range is a sphere on a coordinate system having the batch size, the learning rate, and the momentum as an x-axis, a y-axis, and a z-axis respectively, which has the first core value as a center of sphere. If four parameters such as a batch size, a learning rate, a momentum, and a normalization are set, the first parameter range is a physical quantity range on a coordinate system having the batch size, the learning rate, the momentum, and the normalization as an x-axis, a y-axis, a z-axis, and a w-axis respectively, which has the first core value as a physical center. However, a three-axis space and a four-axis drawn on a plane cannot show an iterative effect, and therefore are not shown herein. Those with ordinary knowledge in the field may conceive transformation between the three-axis and the four-axis space according to FIG. 2 to FIG. 4.

More specifically, if the momentum and the normalization are considered, the momentum ranges from 0 to 1, and preferably, from 0.3 to 0.8, and the normalization ranges from 0.00001 to 0.001, and preferably, from 0.0001 to 0.0005.

Further, in the initialization step S20, in consideration of the momentum and the normalization, any two of the batch size, the learning rate, the momentum, and the normalization may be selected by a first graphics processor, the other two are selected by a second graphics processor, and the accuracy rate is calculated by a third graphics processor. Therefore, by dispersing the computing resources through the three graphics processors, faster computing efficiency and faster gradient descent are achieved.

A comparative example is compared with the embodiment herein. A training set actually used is a standard training set provided by Google. In the comparative example, training is performed by using a standard A1 framework, a Tesla 40m (2880CUDA, 12 GB) GPU, and a google tensorflow mode. In the embodiment, four GTX 1050i (768CUDA, 4 GB) GPUs in a serial connection are used. In the above embodiment, the batch size, the learning rate, the momentum, and the normalization range from 0.7 to 1.3, 0.7 to 1.3, 0.3 to 0.8, and 0.001 to 0.005 respectively for training. A result of the comparative example is an accuracy rate of 86% with 14400 seconds spent. However, a result of the embodiment is an accuracy rate of 98% with 900 seconds spent.

In conclusion, through the parameter iteration method for artificial intelligence training of this application, the selection of parameters can be quickly optimized, and descent and convergence of the gradient can be quickly achieved, helping improve training efficiency, reduce computing resources, and complete the training with fewer hardware costs.

Although the application has been described in considerable detail with reference to certain preferred embodiments thereof, the disclosure is not for limiting the scope of the application. Persons having ordinary skill in the art may make various modifications and changes without departing from the scope and spirit of the application. Therefore, the scope of the appended claims should not be limited to the description of the preferred embodiments described above.

What is claimed is:

1. A parameter iteration method for artificial intelligence training, the method comprising:
a setting step comprising providing a training set and setting a numerical range for at least two training parameters;
an initialization step comprising randomly selecting at least three initial set values from the numerical range for the training parameters, calculating an accuracy rate of each of the initial set values according to the training set, and setting a first parameter range by using the initial set value having a highest accuracy rate as a first core value and using a parameter coordinate value of the first core value as a physical center;
a parameter optimization step comprising selecting at least three first iteration values from the first parameter range, calculating an accuracy rate of each of the first iteration values according to the training set, comparing the accuracy rates of the at least three first iteration values, and setting a second parameter range by using the first iteration value having a highest accuracy rate as a second core value and using a parameter coordinate value of the second core value as a physical center; and
a determination step comprising determining whether the accuracy rate of the second core value is higher than 0.9, if the accuracy rate of the second core value is higher than 0.9, ending the parameter optimization step and setting the second core value as a training parameter standard value, or if the accuracy rate of the second core value is not higher than 0.9, replacing the first core value and the first parameter range with the second core value and the second parameter range respectively, repeating the parameter optimization step until an accuracy rate of a test core value is higher than 0.9, and setting parameter coordinates of the test core value as the training parameter standard value; wherein
the at least two training parameters comprise a batch size and a learning rate, the batch size ranges from 0.5 to 1.5, the learning rate ranges from 0.5 to 1.5, and the first parameter range is a circle on a coordinate system having the batch size and the learning rate as a horizontal axis and a vertical axis respectively, which has the first core value as a center of the circle, wherein the batch size ranges from 0.7 to 1.3, and the learning rate ranges from 0.7 to 1.3.

2. The parameter iteration method for artificial intelligence training according to claim 1, wherein in the initialization step, the selection of the batch sizes and the learning rates of the initial set values and the calculation of the accuracy rate are performed by two graphics processors respectively.

3. The parameter iteration method for artificial intelligence training according to claim 1, wherein the at least two parameters further comprise a momentum ranging from 0 to 1, and the first parameter range is a sphere on a coordinate system having the batch size, the learning rate, and the momentum as an x-axis, a y-axis, and a z-axis respectively, which has the first core value as a center of the sphere.

4. The parameter iteration method for artificial intelligence training according to claim 3, wherein the momentum ranges from 0.3 to 0.8.

5. The parameter iteration method for artificial intelligence training according to claim 3, wherein the at least two parameters further comprise a normalization ranging from 0.00001 to 0.001, and the first parameter range is a physical quantity range on a coordinate system having the batch size, the learning rate, the momentum, and the normalization as an x-axis, a y-axis, a z-axis, and a w-axis respectively, which has the first core value as a physical center.

6. The parameter iteration method for artificial intelligence training according to claim 5, wherein the normalization ranges from 0.0001 to 0.0005.

7. The parameter iteration method for artificial intelligence training according to claim 5, wherein in the initialization step, any two of the batch size, the learning rate, the momentum, and the normalization are selected by a first graphics processor, the other two of the batch size, the learning rate, the momentum, and the normalization are selected by a second graphics processor, and the accuracy rate is calculated by a third graphics processor.

8. The parameter iteration method for artificial intelligence training according to claim 1, further comprising a verification step comprising providing a test set, calculating the accuracy rate according to the test set by using the second core value or the test core value in the determination step that has the accuracy rate higher than 0.9, and performing the initialization step again if the accuracy rate calculated according to the test set is lower than 0.9.
